(19) United States
(12) Patent Application Publication
(10) Pub. No.: US 2020/0135237 A1
(43) Pub. Date: Apr. 30, 2020

(54) Systems, Methods and Applications For Modulating Audible Performances

(71) Applicant: Virtual Voices Pty Ltd, Semaphore (AU)

(72) Inventors: Marty Gauvin, Semaphore (AU); Andrew Downing, Kingswood (AU); Patricia Rix, Ashton (AU)

(21) Appl. No.: 16/627,265

(22) PCT Filed: Jun. 29, 2018
(86) PCT No.: PCT/AU2018/050680

§ 371 Date: Dec. 27, 2019

(30) Foreign Application Priority Data
Jun. 29, 2017 (AU) 2017902531

(51) Int. Cl. G11B 27/036; G06F 16/638; G10H 1/36

(52) U.S. Cl. CPC G11B 27/036; G10H 1/368; G10H 1/365; G06F 16/638

(57) ABSTRACT

Embodiments involve harmonising one or more geographically or temporally distributed renditions with at least one backing clip, comprising a calibration module for selecting a parameter of one or more aural or visual characteristics of the first rendition, a backing clip selector in communication with a backing clip database, a reference selector for selecting reference clip for modification of the first rendition, a modification module for applying a computational process to the first rendition or the backing clip to modify an aural characteristic of the first rendition or the backing clip to reduce the difference between the first rendition or the backing clip and the reference clip in the aural characteristic, and a mixing module to combine one or multiple renditions with the backing clip after modification.

### TECHNICAL FIELD

The present invention relates to systems, methods and software applications for harmonising one or more geographically or temporally distributed renditions with at least one backing clip comprising a calibration module, a backing clip selector, a reference selector, a modification module, and a mixing module. In particular, the present invention may accommodate any number of renditions by end users; which theoretically may be scaled up to a substantially unlimited number. It harmonises the renditions by combining them in a pleasing, aesthetic, unifying or effective audio or audiovisual accord. Optionally, it aspires to inclusiveness and may either ensure that the contribution of each performer is material to or prominent in the finished performance, or may enable singers and other performers with limited vocal or musical range to participate in a performance.

### BACKGROUND

Recent advances in smartphone and connected device technologies have increased the volume and accessibility of recorded digital content; so much so that it is now common for artistic performances by noteworthy performers to be viewed via the web millions of times or even billions of times.

A significant resurgence in music appreciation has been led by the improved accessibility of music content via subscription-based music content platforms such as Spotify and Apple Music, and free or freemium content providers via platforms like YouTube Music. An increasing desire has followed, for listeners to participate in new or existing performances. Many listeners are seeking to create their own performances, along with a backing track or with a backing track and performer, in a karaoke style performance. Others are seeking a connection with other people achievable through music, either to perform a song with a friend or loved one, or to participate in a group performance to achieve a sense of belonging. For instance, performers may be seeking to participate in the tribal following of sporting clubs through the participation in a mass rendition of the club song or victory chant, or indeed they may be seeking to participate in mass church choirs or spiritual ceremonies.

In some situations, many people around the world may all wish to sing the same song but will not have the opportunity to combine their voices directly or at the same time, due to their geographic separation or, or their unavailability at a given time, or the inconvenience caused by time zone differences. However, a very large number of performers may contribute to a performance if each can perform a high-quality rendition at any time or any place of their choosing, and if their rendition can be combined with the renditions of other performers.

Attempts have been made to organise and record the ‘World's Largest Choir’, in which all singers are present at the same time, in the same physical or virtual place. In one attempt, the largest gospel choir, comprised entirely of singers located at one place at the same time, consisted of 21,262 participants and was achieved by the Iglesia Ni Cristo in Ciudad de Victoria, Philippines, on 22 May 2016.

Attempts have also been made to organise and produce recordings of a ‘virtual choir’ comprising groups of participants located in multiple places who record and upload music videos which are then combined (for example, Eric Whitacre's virtual choir). While a high quality output recording was achieved in the Whitacre example, it involved overcoming many technical and logistical challenges. It included predominantly competent singers and choirs (and therefore omitted singers with some or limited vocal competence). It would therefore have inadvertently excluded singers unable to accomplish the full range of notes in the musical score. Further it was a manually intensive process still unable to achieve a scale similar to or greater than the hundreds of thousands that often attend concerts or other in-person performances.

The Huge Choir Project and similar events aimed to produce compositions built from renditions captured and recorded at different locations at different times, with the contributions being mixed manually. The physical effort involved in organising and combining the numbers of renditions collected from each participant has been extensive and the combination of renditions has been very time consuming. The project therefore proved very costly and was highly reliant on participants' generosity of time and financial contribution. The project could only accommodate a small number of specified songs. There were very long delays, sometimes many weeks, between the recordings by the first participants and the production of a composition that participants could see or hear, depriving participants of early viewing of, or listening to, the compositions.

Such issues may be overcome by bringing together large virtual groups of singers, which may comprise an entire cohort of singers, or selected groups of singers. Other methods for capturing and recording group performances allow small groups in different locations to record combined audio or audiovisual renditions that are then listened to or viewed by a large number of people at times and places of their choosing.

Similarly, Karaoke is aimed at small or large groups in a single location with one of the world's largest Karaoke sessions comprising 160,000 participants. These, and the larger scale performances, provide no means or capacity to readily produce individual or personalized recordings of the event comprising each and every performer in a distinct or prominent role, nor do they enable performers with limited vocal range to fully participate in a fulfilling way.

There will be a multitude of reasons why a person wishes to participate in a performance. For instance, a singer may wish to sing the melody or a particular part of a song because they enjoy the song, or they may wish to participate because the song has some special significance. The song may be one which is commonly associated with a person, group, organisation, event or cause.

The power of music, and in particular the impact of participation in musical performances, has long been acknowledged and is now being applied to physical and psychological therapy. The therapeutic impacts of music in emotional regulation have been recognised and are being applied to the treatment of affective depressive disorders such as depression, anxiety and bipolar spectrum. The therapeutic benefit of vocal performance to stabilise tremors associated with Parkinson's disease and to generally improve quality of life, has been recognised in many studies carried out in recent years. Music, especially selected songs which are familiar to or have special significance for an individual, and music sung by their family and friends, can bring joy to persons who are isolated or living with dementia. Selected music may also play a valuable role in behaviour management for persons with cognitive impairment, such as dementia. The benefits of singing have also been realised in corporate and career training; to break down barriers in team building, to overcome shyness experienced in talking or presenting to groups, and to improve theatrical performances by actors and executives.

Vocal performance can be a powerful facilitator of emotional connection and, in turn, can be harnessed to provide therapeutic benefit. However, poor vocal performances can equally create negative self-perception and have a negative impact on self-esteem. Singers who perceive their rendition of a performance as below expectation, or below their perception of ‘self’, may be driven away from vocal performance or may create a negative association with any vocal or verbal public expression.

Certain performers may be unwittingly excluded from performing in pre-planned performances or spontaneous singalongs due to their inability to sing either all the designated note pitches of a song, or to sing the whole of their selected vocal line within a song. This may occur in vocal performances, whether they be public or private performances, if the song is pitched so high or so low that the range of notes in the song extends outside of the comfortable vocal range of the singer (i.e. the singer's tessitura). A person singing within their comfortable vocal range may correspond to the best-sounding characteristic or timbre of their voice.

Many songs are based on an equal-tempered chromatic scale. If the range of notes in a song is outside of the comfortable vocal range of a performer, transposition (i.e. pitch shifting) of the song to a lower or higher key may overcome this difficulty.

Alternatively, it may be acceptable for a performer to perform their rendition one or more octaves above or below the values of the notes contained in the score. Adjustments to accommodate these differences may also be enabled through transposition.

For a specific song, a performer may wish to sing the melody, or to sing a harmony, or to sing other parts or musical notes at a different timing, pitch or duration than that which has been set out or used by a composer, arranger, another performer, or by him or herself. Each song may have multiple parts, variations or vocal lines. In a particular rendition, a singer may wish to sing one or a combination of these parts, variations or vocal lines, or to sing their own preferred variation. All of these scenarios cannot be accommodated by technology currently available to collate, modify and combine recordings.

Smart devices including wearable devices and, in particular smart phones, are hyper-ubiquitous and immersed in the lifestyles of almost all people in the world today. The extreme prevalence of smart devices provides a hardware platform for performers to participate in mass performances of a scale that has not been realised to date. Smart devices carry the necessary hardware to capture individual performances, the necessary hardware to run applications enabling the modification or combination of the performance, and the necessary hardware to transmit those performances and receive the performances of others, and the necessary hardware to play any of these performances.

Every person's vocal range is different and many performers may be unable to accurately sing along with a particular tune as it is played. Additionally, not all performers will be capable of singing an entire song in the same key as the original performer of the song or in the same timing or range as the instrumental performance or backing track. Smart devices provide a useful platform for capturing performances, modifying or combining them with other performances or backing tracks and sharing the new content to the public, a single contact, a closed group of ‘friends’ or simply to retain the composition for oneself.

To avoid alienating performers unable to achieve the quality of performance that has a self-affirming impact on the performer, the performer's rendition or backing track may require transposition or modification to improve the quality of the combined performance. However, the dramatic alteration of the performer's rendition, particularly where the corrected rendition is no longer recognisable as originating from the performer, may be as offensive or alienating to the performer as receiving their original, unmodified rendition. Thus, careful selection of the qualities to be modified and the degree of transposition from the original rendition is needed to create a positive self-realisation that, in turn, engages the performer to create additional renditions and musical works.

### SUMMARY

In a first broad aspect, the present invention relates to a system for harmonising one or more geographically or temporally distributed renditions with at least one backing clip comprising; a computing device for executing a software application, capturing a first rendition and communicating the first rendition to a software application, wherein the computing device further comprises; a processor, a memory, a camera or microphone, a signal transmitter, a signal receiver and a user interface; the software application further comprising; a calibration module for selecting a parameter defining one or more aural or visual characteristics of a first rendition, a backing clip selector in communication with a backing clip database configured to filter a collection of backing clips to select for a backing clip corresponding with the selected parameter, a reference selector for selecting a reference clip to act as a reference point for the modification of the first rendition, a modification module for applying a computational process to the first rendition or the backing clip to modify an aural or visual characteristic of the first rendition or the backing clip to reduce a difference between the first rendition and the reference clip in the aural or visual characteristic, and a mixing module for combining one or more renditions with the backing clip after modification, wherein the resulting combination comprises a finished performance.

In a second broad aspect, the present invention relates to a method for harmonising one or more geographically or temporally distributed renditions with at least one backing clip comprising the steps of: selecting a reference clip to act as a reference point for the modification of the first rendition; generating a first rendition by a user; calibrating the first rendition to select a parameter defining one or more aural or visual characteristics of a first rendition; selecting a backing clip from a backing clip database for combining with a first rendition; applying a computational process to the first rendition or backing clip to modify an aural or visual characteristic of the first rendition or the backing clip to reduce a difference between the first rendition and the reference clip in the aural or visual characteristic; and combining the first rendition, or the first rendition and more renditions, and the backing clip after modification to produce a first performance; wherein the resulting combination comprises a finished performance.

In a third broad aspect, the present invention relates to a software application for harmonising one or more geographically or temporally distributed renditions with at least one backing clip comprising; a calibration module for selecting a parameter defining one or more aural or visual characteristics of a first rendition, a backing clip selector in communication with a backing clip database configured to filter a collection of backing clips to select for a backing clip corresponding with the selected parameter, a reference selector for selecting a reference clip to act as a reference point for the modification of the first rendition, a modification module for applying a computational process to the first rendition or the backing clip to modify an aural or visual characteristic of the first rendition or the backing clip to reduce a difference between the first rendition or the backing clip and the reference clip in the aural or visual characteristic, and a mixing module for combining one or more renditions with the backing clip after modification, wherein the resulting combination comprises a finished performance.

As used herein, the term “rendition” and any pluralisations and derivatives thereof refer to an audio or visual expression by a user of the system, method, or application. It is intended to include, but not to be limited to, vocal expressions using one's voice such as singing, chanting, humming, whistling, speaking, beat boxing, etcetera; non-vocal audio expressions such as the playing of a musical instrument whether digital or analog, choreographed sounds, et cetera; and visual expressions such as movement, gesture, dance, theatrical performances, video footage et cetera.

As used herein, the term “note attribute” and associated terms such as “note attribute values” and pluralisations or derivatives therefore refer to a quality or characteristic of a musical note. Note qualities or characteristics that are considered as “note attributes” include, but are not limited to, the note pitch, volume, reverberation, timing and duration. It is envisaged that persons skilled in the art may readily understand other note qualities or characteristics that may be considered “note attributes”.

As used herein, the term “backing clip” and any pluralisations and derivatives thereof refer to an audio or video sequence that may be sourced from any one of a number of sources, including but not limited to, computer-generated audio or video sequences, musical performances authored by musicians, choreographed performances authored by dancers, physical performers, storytellers, et cetera.

As used herein, the term “computing device” and any pluralisations and derivatives thereof refer to any device comprising a computer processing unit and a memory. This may include, but is not limited to, personal computers, mobile devices such as smart phones, tablets and the like, video gaming consoles, in-car entertainment systems, wearables such as smart watches, fitness and health monitors and the like, and other connected devices such as smart televisions, smart refrigerators, digital radios, audio or audio-visual systems, and other items connected to the Internet of Things.

As used herein, the term “signal receiver” and any pluralisations and derivatives thereof refer to devices and/or components capable of receiving any one of a number of communications signals. This may include, but is not limited to, receivers of signals such as cellular signals, satellite signals, microwave signals, radio signals and other telecommunication signals using technology such as Bluetooth, Wi-Fi, 4G, 5G etcetera.

As used herein, the term “communications network” and any pluralisations and derivatives thereof refer to any network of infrastructure that enables the transmission and receipt of any one of a number of communications signals. This may include, but is not limited to, communications signals such as cellular signals, satellite signals, microwave signals, radio signals and other telecommunication signals using technology such as Bluetooth, Wi-Fi, 4G, 5G et cetera. Information transmitted “over a communications network” indicates that such information is being transmitted by transmitting signals containing that information between discrete infrastructure components of a communications network.

As used herein, the term “communicating” or “in communication with” and any pluralisations and derivatives thereof refer to the process of transmitting communications signals over a communications network or a state of readiness for the transmission of communication signals.

As used herein, the term “computational process” and any pluralisations and derivatives thereof refer to any automated process for modifying or altering information, including but not limited to, simple processes such as filtering, other processes such as transposing, pitch shifting, pitch correction, formant shifting or preservation, noise reduction, volume control, et cetera, or even complex processes including the application of an algorithm to individual files or data sets.

As used herein, the term “database” and any pluralisations and derivatives thereof refer to discrete repositories of information, files, data et cetera regardless of the size of the repository (i.e it could include a single record of information) or whether the repository is structured or unstructured.

Systems, methods, and software applications according to the invention are adapted to produce finished performances, new backing clips or additional renditions to which further renditions may be added, involving renditions from a potentially unlimited number of users. Additionally, users may be geographically or temporally distributed; they may be located anywhere in the world, therefore their renditions may be created or sourced from geographically or temporally distributed locations.

For instance, this may include scenarios whereby a globally distributed congregation is seeking to contribute to a hymn, prayer, chant, or to a complete ceremony or service. In the sporting context, supporters distributed around the globe may wish to contribute to a finished performance of a club song. Alternatively, simply for fun, friends may wish to contribute to a single performance of their favourite track or film clip.

In addition, many forms of the invention enable the user to combine the renditions of different performance types, for example, renditions produced by singers, musicians, speakers, chanters, reciters, protesters, petitioners, competitors, artists, dancers, actors, puppeteers and other performers, which may be combined individually or in any one of a number of combinations.

The ubiquitous nature of connected devices provides a globally distributed network of computing devices in constant communication over a variety of network infrastructures. Such computing devices are, preferably, capable of capturing a rendition performed at the device, executing a software application, communicating a rendition to the application, and receiving and transmitting a signal over a communications network. Thus, preferred computing devices include a processor, a memory, one or more cameras or microphones, a signal transmitter, a signal receiver and a user interface. Suitable computing devices may include personal computers, video gaming consoles, in-car entertainment systems, smart devices such as smart phones, tablets and the like, wearables such as smart watches, fitness and health monitors and the like, and other connected devices such as smart televisions, smart refrigerators and any one of a number of items connected to the Internet of Things. Preferably, computing devices according to the invention comprise smart phones, tablets and smart watches.

Many suitable processes, memories and cameras or microphones according to the invention will be well known to person skilled in the art and are commonly found on almost all smart devices, such as smart phones, tablets and smart watches, available in the marketplace. Preferred computing devices comprise a signal transmitter and a signal receiver capable of transmitting and receiving signals over a cellular telecommunication network, such as 4G or 5G. Cellular telecommunication networks comprise the preferred communications infrastructure for communicating information across networks in accordance with embodiments of the invention, as they enable rapid transmission of information with minimal delay across large distances and across a wide breadth of geographical locations.

In particular, cellular telecommunication networks enable systems, methods, and software applications according to the invention to access cloud-based infrastructure to store database records or information, such as backing clips, away from the computing device and at a location that may be accessible to many users. In addition, the scalability of cloud-based infrastructure may be utilised to ensure that the storage and/or computational processing of backing clips, renditions, modified renditions, and/or finished performances is scalable to accommodate up to a theoretically unlimited number of users or user renditions and associated records.

Thus, it is contemplated that embodiments of the invention may comprise application programming interfaces (APIs) to communicate with third party services. This may include third-party cloud hosting services or any one of a number of other third-party services that may be associated with specific embodiments of the invention, for instance, to enhance functionality.

In particular, embodiments of the invention may comprise APIs to communicate with live streaming services. For instance, users may wish to listen to ceremonies, religious services or other events such as sporting events in real-time so that they may contribute or participate in hymns, chants or even commentary at the appropriate time, in real-time. Embodiments comprising APIs for connecting with live streaming services may enable users to listen to live streams while simultaneously (or approximately simultaneously) capturing, processing and/or mixing a rendition.

In preferred forms of the invention, the computing device comprises a user interface to enable the user to operate the software application. The software application preferably comprises an operational interface presented to the user via the computing device's display. The operational interface allows the user to enter, modify, commence and manage any one of a number of preferences, settings or actions associated with the software application. For instance, the operational interface allows the user to enter user specific information to build a profile. This may include information such as their name (or pseudonym), username, password, group name, membership number, contact details, preferences, information pertinent to the use of the invention et cetera. Certain information may also be collected automatically, such as from GPS location based data, from social media sites or from personal data stored on the recording device. Through the operational interface the user may also adjust preferences and settings such as the visibility of their profile to other groups, accuracy or aesthetic preferences for their renditions et cetera.

The software application of certain embodiments may be able to produce compositions based on the user's demographic or personal characteristics, affiliations, interests, or preferences, collected in their profile.

The modification module may be configured to locate the computational process by calling the application programming interface. The computational process may comprise the modification of a sequence of note attribute values of a first rendition or a backing clip to reduce the difference between the first rendition or the backing clip and the reference clip in the selected aural or visual characteristic.

The first rendition in certain embodiments may comprise one or more vocal performances of one or more user recordings, and the backing clip comprises the balance of the one or more user recordings excluding the one or more vocal performances. The one or more vocal performances of one or more user recordings may exclude any background and incidental noise present in the one or more user recordings.

The first rendition or backing clip and the reference clip may comprise data translations characterised by note attribute values. Therefore, the computational process may comprise the modification of a sequence of note attribute values of the first rendition or backing clip to reduce the difference between the data translations of the first rendition or the backing clip and the reference clip in the selected aural or visual characteristic.

In certain embodiments, the one or more user recordings comprise a video recording of the vocal performance.

The user may also operate the operational interface to initiate a session, select a backing clip from a database located on the computing device or at a cloud location, perform a calibration (including obtaining characteristics of their voice such as vocal range), capture a rendition, perform a computational process, or mix any number of renditions and the backing clip after modification. In addition to the user performing a computational process or mixing renditions etc, they may signal/gesture to initiate such processes and mixes, with the mixes being undertaken elsewhere. The user may also make other selections such as a selection between options, for instance, to save a finished performance to a local device, to add it to a cloud database (where it may also be added to a database of backing clips), or to send it to another user or another person.

Preferred software applications according to the invention comprise a backing clip selector, a calibration module, a modification module, an optional rendition selector, and a mixing module.

A backing clip selector according to the invention may be in communication with a backing clip database located on the computing device or at a cloud location. A backing clip selector may therefore communicate with the memory located on the computing device via standard electrical connections, or it may communicate with a memory located on the cloud which is accessed via a communications network. Preferred backing clip selectors according to the invention comprise the capability to not only source backing clips located on the computing devices memory but also source backing clips located on the cloud, whereby a user may select from information held in databases at both locations. Preferably, a user will operate the backing clip selector via the software application's operational interface displayed via the computing device's user interface. The operational interface preferably displays backing clip options available to the user whereby the user may select backing clip options directly or search for a specific option via keystroke selection. Based on the user's vocal characteristics, the software application may recommend the most likely or suitable backing clips.

Calibration modules according to the invention may comprise several functions, and may become operational at various stages in the operation of the software application to generate a finished performance or an additional performance. Under the instruction of the user, the calibration module may execute a sequence including for example a short video, a set of instructions and/or some practice musical notes to be played in unison with the user, to calibrate or optimise the performance of the rendition. This warm up or practice function may be initiated by the user immediately prior to selecting a backing clip, immediately prior to performing a rendition, between a failed or undesired rendition and a recapturing of a new rendition, or at any other stage independently of a sequence of operations. The user may also manually adjust, activate or deactivate any calibration settings or preferences.

In certain embodiments of the invention, APIs of the software application may enable the calibration module to utilise third-party applications such as Shazam or Soundhound to check that the rendition of the backing clip matches the desired song.

Alternatively, the calibration module may comprise the capability to assess or determine the user's musical or performance range. Performers of renditions may be limited in their ability to perform notes outside of a particular range. For instance, a singer's vocal abilities may not extend outside of a comfortable vocal range, or a player's instrument (or a player's capability to play an instrument) may not extend outside of a set musical range.

The term ‘range’ may lead to ambiguity and confusion when fully defining or describing the extent of the musical scale notes (or pitches) which a person can comfortably sing. There is similar ambiguity and confusion over the use of the term ‘range’ when fully defining or describing the extent of the musical scale notes within a song or a vocal line of a song. Thus, a singer's (comfortable) vocal range is preferably determined and expressed as the two numbers denoting the lowest note and the highest note which a singer can (comfortably) sing, and including all notes in between. A singer's (comfortable) vocal span is preferably determined and expressed as the single number equal to the pitch distance, expressed in semitones, between the lowest note and the highest note which a singer can (comfortably) sing.

Similarly, the range of a (musical) instrument is preferably determined and expressed as the two numbers denoting the lowest note and the highest note which the musician can comfortably and accurately play on it. This may be less than the inherent note range of the instrument itself. The span of a musician's instrument is preferably determined and expressed as the single number equal to the pitch distance, expressed in semitones, between the lowest note and the highest note which the musician can comfortably produce.

The calibration module may determine the vocal or song note range and pitch distance for a singer or musician performing a rendition or for a backing clip. The calibration module may determine the vocal, song or instrument note range and pitch distance for a singer or musician performing a rendition or for a backing clip. The calibration module may make such a determination for both the singer or musician and for the backing clip. The resulting determination is expressed as three values, two indicating the highest and lowest note of the vocal, song or instrument note range, and one indicating the pitch distance between the lowest and highest notes. These values may be communicated to the modification module and may, optionally, form the basis of a computational process applied to a rendition or a backing clip.

It may be particularly advantageous to automatically determine a user's comfortable vocal range (i.e. their tessitura) so that a song can be optimally transposed or melodically adjusted via note value substitutions to suit the singer. As required, reverse transpositions and reverse substitutions may be undertaken at a later stage of the audio processing to facilitate mixing with all other renditions, including those which may also have been transposed to suit other individual singers or groups.

A song melody with a backing clip will often commence in a tonic or home key which will be the same for multiple parts or variations of the song. The tonic key may be selected by the composer or arranger of the score and may also be influenced by the nature or characteristics of the backing instruments.

At various points in the score, a composer, arranger or performer may modify the musical key of a rendition or backing clip to achieve certain emotional or psychological effects such as a change of mood from happy to sombre, or to build excitement and intensity. It is also likely that there will be multiple vocal lines for each song, and each will have its own range of notes to be sung. Depending on their vocal range, a singer may choose to perform one or more vocal or temporal parts of the song that suit their voice, including singing in a higher or lower octave.

In certain forms of the invention, it is highly desirable that the range of notes of the chosen vocal line, and any sung variation, be within the comfortable vocal range of the performer so that they can perform the work with a quality and accuracy which is acceptable to them, to other performers, and to listeners. It is therefore preferable to ensure that every performer of a rendition may find a line they can sing, so that no performer is excluded. This is likely to boost singers' confidence and enjoyment and build a sense of belonging to the group. It is likely to avoid potential disappointment, embarrassment, or distress.

In certain embodiments, the calibration module may not be required to make a determination of the vocal or song note range and pitch distance for a backing clip as this information may be available from third-party sources. This information may nonetheless be associated with a backing clip record, as meta data relating to that record, on a backing clip database. Such information is preferably searchable.

In a preferred form of the invention, the determination of the vocal, song or instrument range, and hence the determination of the pitch distance between the highest and lowest notes, for a singer or musician performing a rendition, or for a backing clip, is performed automatically.

In other embodiments, a user may utilise their own or a manually selected vocal or song note range and pitch distance to select a backing track by filtering the backing track database using these parameters.

In alternative forms of the invention, the backing clip may be a video clip. In such forms, determination of a vocal or song note range and pitch distance for the backing clip may not be necessary. However, visual characteristics of the backing clip may be determined. For instance, cues for background changes, significant movement changes, changes in choreographic or sets, or cues for the entrance or exit of visual characters may be expressed in relation to the backing clip. Visual characteristics may be expressed as time points in the backing clip, symbols, shapes, brightness, colour hues, or the pace of movement et cetera.

In preferred forms of the invention, performance and non-performance audio, video or still images (for example fireworks, advertising or video footage of a crowd, spectators, or audience), may be synchronised to, or incorporated in, the rendition.

The expression of aural or visual characteristics of a rendition or backing clip are preferably communicated to the modification module. Preferred modification modules according to the invention preferably comprise one or more mathematical expressions for performing computational processes. In some forms, the mathematical expressions may be independent of the aural or visual characteristics of the rendition or backing clip, for instance they may comprise mathematical expressions for applying simple filters to audio or visual data. In preferred forms however, these mathematical expressions contain variables that are supplied by values relating to aural and visual characteristics of the rendition or backing clip. In a simple form, a mathematical expression may perform a simple matching of the note range and/or pitch distance on a rendition and a backing clip.

In further preferred forms, a computational process may involve a mathematical expression for ascertaining the note range and pitch distance between a rendition and a backing clip. The computational process may additionally involve a mathematical expression for transposing the pitch of a rendition to match the pitch of a backing clip, or a mathematical expression for transposing the pitch of a backing clip to match the pitch of a rendition by the user. Preferably, a computational process may be capable of both, and may select between either option to generate an output that is aesthetically pleasing.

In a preferred form of the invention, the backing clip will be set to a key that matches or complements aural characteristics of a user's voice and the vocal line they wish to perform.

In a preferred form of the invention, the backing clip will have associated MIDI data for the notes the user should sing when accompanied by it. These MIDI notes identify the tempo, note duration, loudness and pitch that the user's performance will be corrected to. Optionally, the user can select the extent to which the software will apply these changes and so allow them to create a rendition with more or less freedom of personal expression. Throughout this process, the characteristics that make each user's voice recognisable (such as formants, vibrato, resonance) will be retained.

In other embodiments of the invention, the computational process may involve an automatic checking that the rendition meets musical and technical correctness and quality criteria, for instance that it contains acceptable lyrics including words with no profanities.

Additional computational processes performed by the modification module may include the filtering or removing of noise from individual recordings, the detection of attempts to send incorrect data, the detection of multiple user renditions within a single group (for example for competition entries), the monitoring of the quality of incoming audio or video, confirmation of the number of performers in a group, removing or attenuating the backing noise from a rendition by a choir or individual performer, normalising the volume of each performer or group, fitting the rendition inside a song volume envelope over its duration, automatically checking and adjusting note or sound position, duration and pitch et cetera.

Certain forms of the invention may optionally comprise a rendition selector.

The rendition selector may establish one or more rendition pools, and may add selected renditions to one or more pools. The rendition selector may also add one pool to another pool.

The rendition selector is capable of sourcing any number of geographically or temporally distributed additional renditions from any number of geographically or temporally distributed computing devices over a communications network. As the geographically or temporally distributed additional renditions are located on as many geographically or temporally distributed computing devices, or are located at a cloud-based location, the number of renditions that may be accessed by the rendition selector is unlimited in number.

The rendition selector may be capable of sourcing renditions of users based on characteristics, properties, or qualities of the user, including age, gender, ethnicity, language, religion, voice type, and the like. Each pool according to the invention may be associated with one or more characteristics, properties, user qualities etc.

The rendition selector is capable of sourcing renditions of users affiliated with a club, sport, group, family, school, class, church, organisation, or with some other association, membership, purpose, or cause.

Such additional renditions may include renditions performed by the user. In this instance, the user may produce a finished performance which is contributed to the backing clip database and forms an additional record within the database of backing clips. Such renditions may be located by other users who belong to the same group, or it may be located by other users in other ways, who in turn produce a new finished performance based on the performance contributed by the first user in combination with a new rendition produced by the other user. This process may repeat time and time again such that a theoretically unlimited number of renditions may be created by a theoretically unlimited number of users who contribute their renditions to an unlimited number of finished performances. In this form, as each rendition is added to the backing clip, various aural qualities are weighted with respect to the backing clip. Preferably, renditions are aggregated into finished performances in ways that endeavour to minimise the introduction of calculation errors, minimise deterioration in any singer's rendition, and minimise the total time to produce a finished performance.

In this embodiment, each rendition contributes to one or more pools of renditions. A pool may be associated with the characteristics and properties described above. Within a pool, each rendition is combined with the other renditions in the pool using an application specific binary mixing method, or other binary mixing process.

In this embodiment, the mixing module performs a combination of all vocals mixed using an application specific binary mixing method or other binary mixing process, or similar, and will then be added to an instrumental track(s). Effects may, optionally, be added at the same time. However, this process may be performed by the mixing module time and time again such that it performs as many mixes as there are renditions by users up to a substantially unlimited number.

In one form, the mixing module may delete a finished performance produced by a user once it has been used as a backing clip by another user.

Additional renditions according to embodiments of the invention may also comprise the renditions produced and contributed by other users, preferably, following modification but prior to mixing and producing a finished performance.

In this instance, the mixing module may allow a user to select from the additional renditions produced by other users to aggregate with their own rendition prior to mixing with the backing clip. This may be achieved by the mixing module by aggregating a set number of additional renditions produced by other users within a substantially unlimited number of groups, which are in turn aggregated in accordance with a set number of groups across an unlimited number of subgroups, and so forth. Once all groups are aggregated to a single group this aggregate may be communicated to the mixing module to combine with the backing clip or a designated audio-visual accompaniment. Application specific binary mixing methods or other binary mixing processes provide an alternative to this approach, which ensures that each rendition is mixed with others the same number of times as every other rendition to ensure equal quality.

The mixing module may perform such aggregations in accordance with a set of predetermined rules or processes for mixing.

While this process may require additional processing capacity and therefore may involve small time lag, it provides a more balanced finished performance, with the backing clip or designated audio-visual accompaniment. The contribution of every single rendition may also make a distinct difference to the finished performance.

The computational process of embodiments may comprise the modification of a sequence of note attribute values of a first rendition or a backing clip to reduce the difference between the first rendition or the backing clip and the reference clip in the selected aural or visual characteristic. The computational process may further comprise the step of splitting one or more vocal performances from one or more user recordings, wherein the balance of the one or more user recordings excluding the one or more vocal performances remains.

Additional steps may comprise the step of removing any background or incidental noise from the one or more vocal performances by recognising the one or more vocal performances within the one or more user recordings and removing all sound from the one or more user recordings that is not recognised as the vocal performance.

The computational process may also comprise the step of analysing the first rendition or backing clip and the reference clip, translating them into data characterised by note attribute values, and reducing the difference between the note attribute values of the first rendition or backing clip and the reference clip. Additional steps include modifying a sequence of note attribute values of the first rendition or backing clip to reduce the difference between the data translations of the first rendition or the backing clip and the reference clip in the selected aural or visual characteristic. The computational process of some embodiments may comprise the step of modifying a video recording of the vocal performance.

Certain embodiments require a singer to accompany a backing track supplied by the system to facilitate the mixing of renditions. However, there will be situations where a rendition is not closely aligned temporally with a system backing track. Examples of this include:
Timing differences due to a singer performing one or more sections of the song at a higher or lower tempo than the backing track.
Timing differences due to a singer's performance of one or more sections of the song being delayed or advanced relative to the backing track.
A singer performing a cappella, without the backing track.
The singer adding or deleting one or more sections of the song.
The singer using a different backing track or accompaniment from that supplied by the system.
The singer wishing to vary the tempo or timing to create a more personal rendition.

For such renditions, the system may compare and analyse the rendition with a backing clip from its database of backing clips for the song. Correlation techniques may be one of the methods employed during the analysis. Based on the analysis, the system may then apply one or more processes to the rendition to improve its temporal alignment with an existing backing track. The processes may include temporally stretching, compressing or shifting one or more sections of the rendition, deleting one or more sections, or inserting one or more sections of the rendition.

In a preferred form of the invention the mixing of renditions and backing clip or accompaniment, for instance, their synchronisation and compilation, is performed automatically.

Preferably, all finished performances are communicated to the backing clip database, which may be located on the computing device or at a cloud location, where they are stored and maintained as additional records. Appropriate access rules are preferably applied to all finished performances once added to the backing clip database, which are preferably set by the user. For instance, access rules may prevent access of backing clips by users utilising other computing devices, or outside of a particular group.

Preferably, individually personalised compositions are automatically produced for the user, incorporating the user's rendition following processing for each and every performer of a rendition group of performers.

The invention now will be described with reference to the accompanying drawings together with the Examples and the preferred embodiments disclosed in the Description of Embodiments. The invention may be embodied in many different forms and should not be construed as limited to the embodiments described herein. These embodiments are provided by way of illustration only such that this disclosure will be thorough, complete and will convey the full scope and breadth of the invention.

### DESCRIPTION OF EMBODIMENTS

### Brief Description of the Figures

FIGS. 1a and 1b provide flow diagrams illustrating key events in the end user's journey through use of embodiments according to the invention.

FIGS. 2a and 2b provide flow diagrams illustrating the central stages, events and processes in an exemplary embodiment of the invention.

### EXAMPLES

Several embodiments of the invention are described in the following examples.

Systems according to the invention will commonly be embodied as downloadable applications executed on a smart device such as a smart phone or tablet or as applications downloaded as part of a web page and executed within a browser on a smart device. It is anticipated that embodiments of the invention may equally be performed within another software environment such as a web browser, Amazon Echo etc, or via other connected devices. Thus, the following embodiments are exemplary in nature only and are not intended to be limited to execution using the exemplified hardware or network infrastructure.

### Group Song Scenario

In one scenario there may be a particular song that a large number of people wish to sing together. The singers may be connected and united by a common bond, interest, cause or purpose. For example, they may all be;
followers of a certain sporting club,
members of a nation or members of an organisation such as a church,
members of a family,
fans of a certain artist or celebrity, or
advocates for a common cause such as human rights, the environment or world peace.

They may select a song to sing together which is commonly associated with the club, family, organisation, nation, artist, celebrity or cause. Joining together in song is a powerful way of expressing and demonstrating their allegiance, commitment, support, loyalty, love, or sense of belonging. Embodiments of the invention may be utilised to enable such large groups to sing together or form a single composition.

### Greetings and Well Wishes Scenario

In another example, a performer may wish to compose and produce a composite audio-visual message to extend seasonal greetings or birthday wishes, or some other message to relatives, friends or other persons. In this scenario, embodiments of the invention may utilise a backing track and an application to enable the performer to sing, speak, act or in other ways perform their seasonal greeting or birthday message.

The message may have multiple parts, including sung, spoken and other performance elements, at least one of which is contributed to by the performer. The sung part, or other parts, may include contributions from other singers or performers. For certain wishes and greetings, such as birthday wishes and seasonal greetings, the renditions of many performers may be incorporated. Embodiments may also combine selected parts of the message with the renditions of other performers who have used the same or a related backing track provided by the application on a device or through a web interface.

### User Journey

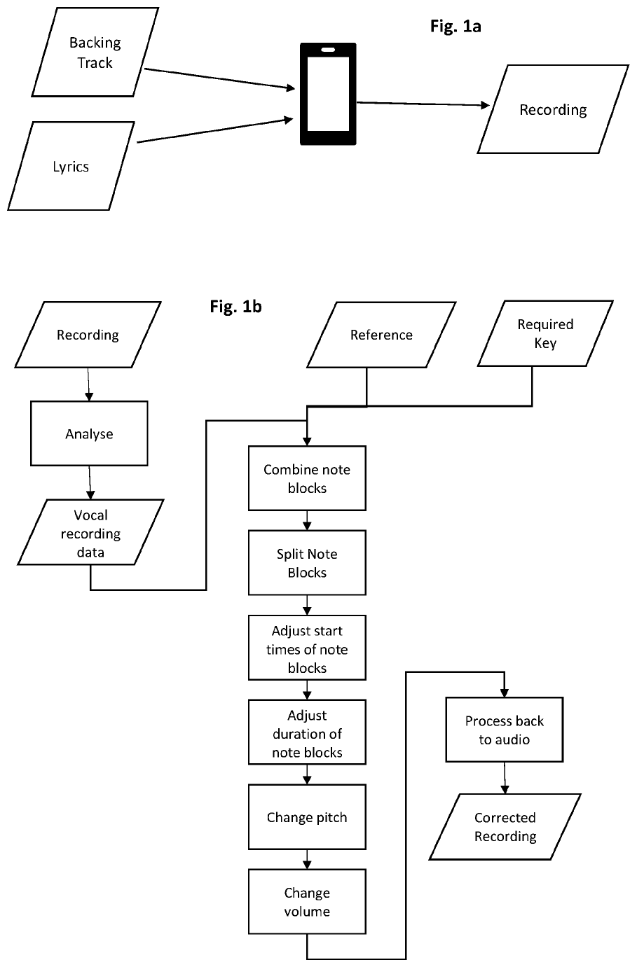

The following, together with FIGS. 1a and 1b, describes a user journey for embodiments of the invention executable via an application downloaded and launched from the user's smart device.

The user is initially required to submit personal details that populate their profile. It may also be possible for users to be identified by their device alone, and for details to be obtained from the device. It may also be possible for users to use their credentials to another service (using the OAuth2 protocol in common with services such as Google and Facebook) and so automatically share selected details.

The personal details may include:
Their name, a group name, or a pseudonym (some performers may prefer to set up several profiles).
Their membership number (where applicable, for example for club-sponsored songs like ‘You'll Never Walk Alone’).
Their email contact details.
A password.
   These will collectively distinguish each performer. Additionally, the user may also submit the following personal details to their profile:
Their location including country, city and postcode or zip code.
The number of singers or players in the group.
Their age (within a range) or their range of ages (e.g. 15-75).
Their date of birth.
For instrumentalists, which instrument(s) they will be playing (may be selected from a pull-down list e.g. brass, woodwind, string, percussion, guitar).
For singers, the classification(s) of voice(s) (e.g. male / female or SATB or child). For a choir, it may be possible to identify all groups. Alternatively, this may be determined and refined by the application by analysing the performer's voice as they sing.
For singers or musicians, favourite musical genres, for example rock, jazz, blues, folk.
For singers, favourite backing instruments such as guitar, saxophone, etcetera.
Affiliations, for example, sports of interest, preferred Football Club Name(s), religious associations, or cultural heritage, et cetera.
Locations or cultures in which they have lived.

Once the user makes their music or song selection, they will be provided with an audio or video backing track. Once the user is ready, they can find a quiet space, put their earbuds in (or set up their headphones or loudspeakers), start the backing track, and sing into their phone.

The user can then upload the rendition by pressing the upload button within the application and waiting for confirmation that it has been received. Typically, however, the rendition will be automatically uploaded once recording has commenced or is completed. A cloud-based system host will immediately process their rendition and send the user their polished solo, or their group rendition wherever members are located, combined with the backing track.

The user will have received a track featuring themselves as the soloist with the original band backing their performance. Next, the user can make a selection via the application on which versions of the song they would like to receive from the cloud-based host by selecting one or more of the following options, with or without accompaniment:
All voices mixed or weighted equally (allowing for the number in a choir or group).
All voices mixed or weighted equally.
The user's voice as a solo, above all other voices.
The original (raw) voice in the original key.
The user's modified voice (minor corrections for pitch, volume, duration) still in the key used for their recording.
The user's own voice with the original recording artist, backed by all other voices.
   Special mixes may also be offered by the application including:
All female performers, all male performers, or all child performers.
Performers affiliated with a nominated group (eg a social or local sporting club, or members of a family).
Performers from a particular country, state or region (for example from the user's home state or city).
Mixes in different styles or genres
Mixes with different accompaniments (for example, a single instrument to a full range)
   Generally, these versions will be transposed by the application to the key in which the user recorded their voice. Alternatively, these versions will be transposed by the application to the key in which the original artist recorded the song, or to a key which suits the majority of singers within the group.

### Election of Vocal Range

### Background

The chromatic scale with 12 notes per octave is used in Western music. The interval between successive notes is one semitone. In an even-tempered chromatic scale, the frequency of successive higher notes is greater than the frequency of the previous note by a multiplying factor which is the twelfth root of 2 (2^{1/12}). Scientific Pitch Notation which describes each note in a scale, including accidentals (flats and sharps) and the octave number. For example, middle C on a piano is designated C4. In some descriptions, reference is made to MIDI Notation. In the descriptions, references are made to the term frequency and to the term pitch which is a person's auditory perception of a note's frequency, with pitch being the more widely accepted term by singers. Those skilled in the art will appreciate that this invention and similar descriptions will also apply to other musical scales, intervals, notations or terms.

To unambiguously define the range of a singer, it is necessary to specify two values, these being the lowest comfortable note they can sing, and the highest. Similarly, to unambiguously define the range of each vocal line of a song, it is also necessary to specify the lowest note and the highest note of that vocal line.

The singer's comfortable vocal range, or tessitura, is expressed as two numbers, these being the actual lowest and highest notes they can comfortably sing and all notes in between. For example, an alto singer may comfortably produce notes on an even tempered musical scale extending from F3 to D5. This defines their tessitura. A singer may have a vocal range which matches all or part of one of the commonly named vocal ranges such as soprano, mezzo soprano, alto, tenor, baritone, bass or child.

Naturally, a significant number of people will have ranges that encompass parts of two adjacent named vocal ranges, or extend beyond them. A significant number of singers will have a smaller comfortable vocal range than these, possibly only 1 to 1½ octaves or 12-18 semitones. Children's and adults' voices differ. For example, a comfortable range for most untrained school-age children up to around age 9 would be from middle C (C4) or possibly B3 up to C5 or possibly D5, just over an octave. Most would struggle with a low A or a high E.

The middle notes of a singer's voice generally make up their most comfortable range. Even though they will have higher and lower notes available and accessible, these will not necessarily be as strong or as desirable in tone as the middle notes. During the performance of a rendition, it is critical that the singer can reliably, consistently and comfortably sing every note in their selected vocal line. Many embodiments of the invention, therefore, will involve an assessment of the comfortable vocal range of each singer from the recording of their first rendition, or even subsequent renditions, using the application. This will determine the compatibility of the user's future song selections with the backing track.

Many singers will not know their vocal range, or the voice classifications which they most closely match, nor have the capacity to readily and reliably measure it. Thus, embodiments of the invention will perform an automated assessment of the comfortable vocal range of each performer. An acceptable vocal range will include all musical notes that a person can sing with relative ease, sufficient accuracy, volume/strength, clarity, quality and consistency. It will also include the singer's lowest comfortable note, their highest comfortable note, and all notes between. The total breadth of notes within each singer's comfortable vocal range is known as their vocal span, for example, if a singer can comfortably sing every note from and including middle C (C4) to the F# in the next octave (F#5), their comfortable voice range covers 19 notes and they have a vocal span of 18 semitone intervals.

Some singers may have multiple comfortable vocal ranges. For example, a male singer may be able to achieve one range in their normal ‘chest’ voice and a different higher range with their ‘head’ or falsetto voice. Embodiments of the invention are capable of measuring multiple tessiture.

### Method

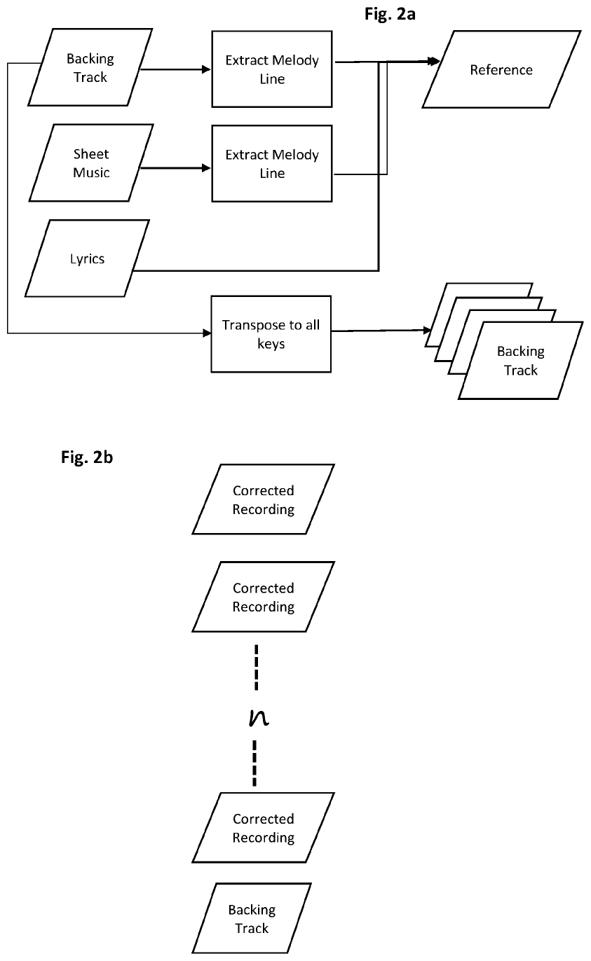

As shown in FIGS. 2a and 2b, prior to the vocal range assessment, the application will instruct the user to take their device and move to a quiet location, free of noise and distractions. The application will instruct the user to wear earbuds, if possible, or headphones, so that they can hear pure notes or other accompaniments. The user will need to view the screen, both for onscreen prompts and, later, for videoing themselves while singing. The user will be invited to commence singing and recording to their selected backing track.

The application will analyse attributes such as purity, consistency of pitch, and strength and consistency of volume of each sung note and produce a figure of merit to indicate whether note production has been successful. Overall analysis of all notes will reveal the singer's comfortable vocal range, the regions of their voice which feel and sound most pleasing or attractive to them and to listeners, and the favoured or most prevalent fundamental frequencies of their voice. Details of this analysis will be stored by the application, either locally or in the cloud, where it is associated with the singer's profile. Subsequently, the application will refine its knowledge of the singer's vocal range and their tessitura with each new rendition.

The application will check each sung note for accuracy, consistency of pitch, and strength and consistency of volume. It will record the singer's success in producing these tones. The software will also identify whether the singer sang the exact notes of the song, or whether they sang a harmonically related set of notes (including those one octave higher or lower).

By analysing each note attempted, the application will make allowance for singers who do not have a good ear for pitch. The software may do this by playing a note for a sustained period and augmenting the normal sound prompts for each note with other visual and/or aural cues to encourage the singer to raise or lower the pitch of the note they are producing. Similar assistance may be required in later stages of the automatic range determination process.

### Highest Note Assessment and Lowest Note Assessment

The application will proceed to determine the singer's highest comfortable note. The application will seek to find the highest note which the singer can comfortably, strongly and reliably sing. Similarly, the application will determine the singer's lowest comfortable note by finding the lowest note which the singer can comfortable, strongly and reliably sing.

### Confirmation

Following the successful completion of the vocal range assessment, the application will generate a record of the singer's lowest and highest comfortable notes within their vocal range, and the span of their voice (the number of semitone intervals between their lowest and highest notes). The application may further reduce this by a margin at each end of the range, to ensure the singer is comfortable within their register.

A more detailed analysis of vocal characteristics will measure the quality of each note produced by the singer. For any song having a vocal span of m semitones, there will be one grouping of m consecutive notes within the singer's vocal range that yield the best overall quality and will be best suited to that song. When selecting the singer's backing track for that song, it is desirable that the key of the backing track be selected so that the singer operates within the best available section of their vocal range. This will enhance the pleasure and success enjoyed by the singer. The singer's backing track may be derived from an original recording by an artist commonly associated with the song. While part of the singer's pleasure will be derived from singing along with that artist, in a key that suits the singer, it is also desirable that the magnitude of the shift in key between the artist's original key, and the key of the backing track be small, to maintain the recognisability and authenticity of the artist.

The application software will automatically select the best key for a song, however the singer may also select the key manually.

The singer's comfortable vocal range(s) will be stored as part of their profile so that, on future occasions when they wish to sing any song, an appropriate backing track can be quickly selected, played and trialled. The singer's profile will also contain their personal song database. This will store details of appropriate backing tracks for selected songs, as well as their renditions, and details of key transpositions to be applied to the backing tracks for use by the application.

Using an appropriate monophonic or stereophonic backing track supplied by the application, each singer or group, will sing, capture and upload their rendition of the song in a key matched to their voice. The singer may perform while listening to a supplied backing track, or the backing track mixed with their own voice to a user-selectable degree, a practice known as foldback. They may also be watching a video, displayed on their device, such as other artists and singers performing the lyrics of the song, or scrolled lyrics, instructions, cues, or prompts. The singer may sing the actual notes in the backing track, or notes which harmonise with it. In some cases, the supplied backing track may have been modified by a music arranger so that it is within the comfortable vocal range of the singer. The modification may be achieved by the music arranger substituting lower melodically appropriate notes for selected higher notes in the unmodified backing track, or substituting higher melodically appropriate notes for selected lower notes in the unmodified backing track. The singer's sound may be captured using a single microphone or multiple microphones.

The singer's audio-visual performance or rendition will be captured and recorded on their device. Normally, the captured audio component of the singer's rendition will be just the singer's own voice. The user may also wish to produce multiple audio-visual contributions, including playing a musical instrument, or dance, either singly or in combination.

The singer's voice is maintained separately from any backing track to reduce interference or contamination from the backing track, and to minimise the degradation that may occur through multiple transpositions or pitch shifts of a track. If necessary, the backing track could be suppressed from the singer's vocal performance using cancellation techniques.

The singer initially creates their rendition by singing to a backing track in key p which has been selected based upon their vocal range. Noise reduction or cancellation techniques are used to isolate the vocal recording in the rendition. The vocal recording is then passed through an analysis phase which produces information on note blocks indicating pitch, start-time and duration. This is the vocal recording data. The analysis step identifies the approximate key that the recording was made in (key q). The vocal recording data is then processed through a number of passes that modify it and align it to the reference in key q.

These passes involve:
Combining note blocks together.
Splitting note blocks.
Adjusting the start time of note blocks.
Increasing or decreasing the duration of note blocks.
Changing the pitch of note blocks.
Changing the volume of note blocks.
   The new vocal recording data is then used as a set of instructions to modify the original recording. New versions of the vocal recording data are also generated in key p and the key of the original recording (key r) and these instructions are used to generate additional versions of the original recording.

Voice recognition techniques will be employed by the application to check that a singer is using the correct lyrics. This will also detect and reject renditions which are incorrect or profane, and avoid corruption when renditions are mixed. Each rendition will be checked for technical quality and will only be accepted if technical quality standards are met. Performers will be able to record and upload replacement renditions, if necessary.

### Spoken Word Scenarios

A senior religious leader such as the Pope, an Archbishop, Imam, Grand Mufti, or Pastor may recite and record a prayer, reading, chant, declaration, utterance etcetera. The religious group may enable its members or followers to say the recitation with one of its leaders using the embodiments described herein. Through use of applications described in these embodiments, the leader's recitation may become the backing clip, and tens of thousands of followers, or members of the virtual congregation, may speak the words with the leader. The leader's recitation may also become the reference with each of the followers of members ‘performances’ being corrected against the leader's recitation. In this scenario, the leader's recitation may be both the reference and the backing clip. The application may convert the backing clip to multiple languages so that the recitation may also be offered to congregations in multiple languages. The leader may also recite the backing clip in other languages, so that the recitation may be offered to congregations in multiple languages.

In another scenario, a group seeking to garner public support behind an issue, or to instigate political change, may utilise systems according to the invention to aggregate individual signatories to a petition. Rather than a written request and written signature, systems described in these embodiments may be used to facilitate a scalable spoken petition. Tens of thousands of petitioners could voice their request, in unison with a backing track spoken by a lead petitioner. Petitioners may be authenticated by executing vocal analysis techniques via the downloadable application. Instead of a written signature, the petitioner's voice could provide sufficient verification.

### Assessment of Song Note Ranges

### Background

Once the application has generated values for the user's musical range and the span of that range, the user will be invited to select a song via the application interface. The selection may be made by searching the system's database for songs known to the user, or from one or more lists of songs displayed on the user's device.

For a selected song, the song will generally have been set in a particular tonic or home key and comprise one or more parts which contain sequences of notes of pitch, duration, timing and other attributes specified by either the composer, an arranger or an artist who has performed this piece. While some singers will be able to sing their chosen part or variation in the key(s) in which the piece is set, many will not because some notes to be sung are likely to be outside of the comfortable vocal range of a sizeable proportion of the potential singers.

A song melody will typically have a note range of about one octave (12 semitones), although many songs, including popular songs by well-known artists, will have greater note ranges. While songs may have been composed in a particular key (or keys), there will be occasions when the key has been changed to suit a particular singer or accompaniment. For example, some popular melodies and the key in which they are commonly played and sung are shown in the table, along with the starting note, the lowest and highest notes of the song, and the span (in semitones).

| | | | | High- | Span |
|---|---|---|---|---|---|
| | Start | Start | Lowest | est | (semi- |
| Common Song Title | Key | Note | Note | Note | tones) |
| Happy Birthday to You | F | C4 | C4 | C5 | 12 |
| Happy Birthday to You | D | A3 | A3 | A5 | 12 |
| He/She's a Jolly Good | D | A4 | D4 | B4 | 9 |
| Fellow/Woman | | | | | |
| The Star Spangled | B^{b} | E^{b}4 | A^{b}3 | E^{b}5 | 19 |
| Banner | | | | | |
| We Wish You a Merry | G | D4 | D4 | D5 | 12 |
| Christmas | | | | | |
| All I Want for Christmas | G | G3 | G3 | D5 | 19 |
| is You | | | | | |
| Somewhere Over the | C | C4 | B3 | C5 | 13 |
| Rainbow | | | | | |
| We Are the Champions | C minor | G4 | G4 | C6 | 17 |

During the recorded performance, it is highly desirable that the singer is able to comfortably produce all notes in their selected vocal line. Therefore, in the present embodiment, the application will determine the vocal range of each singer and the note range of the line of the backing track selected, prior to recording the rendition. In addition to establishing the vocal range of a singer, the application will determine the range of notes in all lines; whether unison, soprano, mezzo, alto, tenor, baritone or bass. This information may not necessarily be provided to the user but will be collected by an artificial intelligence tool for refining the profile for that user. Typically, users will elect to perform renditions of songs within their vocal range. Even so, the application is able to automatically correct notes that have not been sung with sufficient pitch or timing accuracy.

The song note range is expressed in terms of the lowest and highest notes (for example from D4 to G#5). Less precisely, it may be expressed by the song note span, i.e. the number of semitones between the lowest and highest notes. For example, a song whose note range extends from D4 to G#5 has a song note span of 18 semitones. The magnitude of the song note span is independent of the key in which it is played, whereas the absolute song note range, as defined by the lowest and highest pitched notes, changes as the starting key is changed.

To adjust for the discrepancy between the singer's vocal range and the song's note range the application enables the transposition of the song and its backing track to a higher or lower key. That way, the selected backing track may more appropriately match each and every singer's vocal range. This avoids any disappointment and frustration on the part of the singer, particularly in instances where it is important to the singer to participate.

A Musical Director may be involved in arranging or orchestrating each song to produce a master sound track comprising tracks of one or more instruments, voices or synthesised sounds. This may be stored at a cloud location accessible to the application executed on the user's device.

From the Master Sound Track, a Music Team may extract instrumental tracks related to the melody and each part sung by the singers. These may include multiple transposed tracks for the melody and each of the parts. The application will synchronise all tracks to the Master Sound Track.

Noting the key in which a selected song is most commonly sung, the Musical Director may determine the starting key for the song, as well as any key changes occurring in the song. The Master and backing tracks will be produced in this key and a series of secondary backing tracks will be produced to support the parts singers may select. These will also be available in other keys to match the vocal range of each singer.

In situations where the original note span of a song is higher than the vocal span of a number of singers, the Musical Director may produce a modified arrangement of the song with a smaller span of notes that will enable them to sing every note. The arrangement will harmonise with the original song arrangement, and may be combined with it. Singers may choose to use the modified arrangement, which will come with a corresponding backing track in a key that enables them to comfortably sing every note and to record and submit a rendition to be combined with other singers' renditions of the original or modified arrangement. In situations where the original note span of a song is higher than the vocal span of a number of singers, the application may automatically produce a modified arrangement of the song with a smaller span of notes that will enable them to sing every note. The arrangement will harmonise with the original song arrangement, and may be combined with it. Singers may choose to use the modified arrangement, which will come with a corresponding backing track in a key that enables them to comfortably sing every note and to record and submit a rendition to be combined with other singers' renditions of the original or modified arrangement.

### Methods

Prior to commencing a performance of a rendition, it is advantageous for both the application and the singer to know the melody of the song selected, the available vocal lines or parts, the absolute note range of the melody and every other line, the most common key in which the song is sung, and the singer's starting note as well as its timing position in the backing clip. This information may be stored in a cloud-based database associated with the application, alternatively it may be gathered from external sources. Thus, in several embodiments the system may comprise application programming interfaces (APIs) for connecting with third-party databases. In particular, APIs may enable the exchange of meta data associated with songs, video clips and other performances.

The API provides a range of functions for communication between an application running on a user's device and cloud computing and storage resources. These include:
Obtaining or streaming backing tracks for specified songs in a specified key.
Sending recordings to the cloud.
‘Cleaning up’ and analysing recordings, applying corrections based upon specified references and returning corrected recording.
Mixing a specified list of recordings together with specified weightings.

As singers will often not know the note ranges of songs which they are interested in singing, the present embodiment comprises a database which contains information about the note ranges of popular songs that users of the system are likely to wish to perform.

In one particular embodiment, the system comprises a backing clip analysis module that discovers and analyses popular songs to determine the highest and lowest notes of the principal vocal line(s) within each song. This information is added to the system database. When a user has the application set to active listening mode, the application will identify the song being played through the user's device, it will compare the song's note range with the singer's vocal range, it will choose the key which best brings the song in line with the singer's vocal range, while maintaining the authenticity of the artist, and it will produce the transposed version of the song in real time for the singer.

The user can then manually switch from the original version of the song being played to a transposed version via selections made on their device. Alternatively, the user can arrange for the selection to occur automatically, so they can listen to and sing along with their chosen song. When the user is ready, they can record and share their ‘singalong’ rendition.

### Capture and Transposition of Vocal Line

### Background

Once a singer has selected the vocal line they wish to sing, and their vocal range and the range of notes in the song have been determined, both the song and the vocal line can be transposed to match the singer's vocal range.

In other situations, an individual or small group of singers may wish to perform one of the hundreds of thousands of other songs that they can access on a device that runs the application. As it is not economically feasible to manually produce a large number of specific backing tracks for small numbers of performers, the singer may wish to sing along spontaneously and record themselves over the song, either as it is already rendered, or transposed by the application in real time to a suitable key.

### Method

Once the singer has performed their vocal line while listening to the associated backing track, the application checks the rendition for authenticity, accuracy and quality. It then uploads the rendition to the cloud. Depending on the specific qualities of the rendition, a variety of processes are undertaken to enhance the rendition, these include pitch correction, timing correction, volume adjustment and noise reduction, which in turn, yields a ‘polished’ rendition. The polished rendition is retained for later mixing.

If the sung notes in the rendition do not match the notes in the chosen vocal line, the application may adjust the volume profile, pitch and timing of each note in the rendition to reduce differences and bring them within a tolerance level. The application may also combine and split notes in the rendition in order to match the backing track.

The application also accommodates singers who deliberately sing alternative lyrics or notes sympathetic in timing, pitch, duration and other properties to the notes in a backing track of the song.

The application will allow a singer to over-ride or modify selected processes normally associated with the polishing of their rendition. In this way, the singer can deliberately change the characteristics of their performance of selected notes in a song. These characteristics may include, but will not be limited to, the note pitch, volume, reverberation, timing and duration. The singer may also embellish notes, ad lib, or add other sounds of their choosing. Such renditions will be available for incorporation in output mixes that feature this singer. Because these renditions exhibit significant differences from the backing track, they may not be as appropriate for combining with other singers' renditions on a large scale, for example when compiling a chorus.

### Transposition of Backing Track

### Background

The following describes the incorporation of the performer's rendition with the backing track to produce a new composition from the audio and visual performances of individuals and from other audio visual sources.

### Method

The application will select the degree to which a song needs to be transposed to match the comfortable vocal range of the singer. Some singers who can confidently and strongly sing both their comfortable lowest note and their comfortable highest note may not confidently sing every note in between, particularly if these notes are in the near vicinity of the break point in their vocal register. In such cases, the application will provide an option for the singer to manually adjust the amount by which the original song recording is transposed, so that the singer can optimise their own performance.

### Pitch Shifting of Songs

A small vocal range may restrict a singer's choice of songs, or parts or variations of songs, to those with a song span no greater than the singer's vocal span. Furthermore, there are a limited number of keys in which the song may be set, to ensure all notes are within the singer's reach. To allow the maximum number of singers are to have the opportunity to contribute to a virtual choir, songs are made available in multiple keys so that at least one will suit each singer's range.

During the performance of a song, each singer will contribute a rendition in their personal optimum key for that song. To combine all contributions, the renditions of each singer will be transposed back to a selected common key, which is preferably the original key set by the composer, arranger or artist. In transposing a vocal rendition, care will be taken to shift the pitch of each note while largely preserving the formants—the resonant frequencies associated with the shape and dimensions of the singer's vocal tract. This will maintain the qualities of the voice that enable it to be recognised as the voice of the singer.

The characteristics which identify a particular singer include:
Spectral characteristics of how they sing a particular note,
Pronunciation factors,
Volume and pitch ‘ramp in’,
Volume and pitch ‘ramp out’.
   All of these are determined on a note by note basis. The techniques used allow shifting by up to four semitones in either direction with very good results and by a further two or three semitones up or down while remaining effective. Potential improvements to the capability of the system in this regard will be well known to those skilled in the art. The system is in modifying the duration of the note from 0% to 200% or more of the original duration.

If the singer's backing track has been transposed relative to the original track, the singer's polished rendition may be used immediately, or stored for later use, or be transposed back to the key of the original track at which time it can then be stored. If desired, the singer's polished rendition may be transposed to another key for immediate use or storage.

These transposed, polished renditions of all performers will be compatible with one another so that they can be combined or mixed directly with appropriate weighting factors. Embodiments of the system will store the transposed polished renditions from all individuals or groups such that each stored rendition may in turn contribute to one or more mixes of a particular song.

The system will analyse each singer's voice and identify key characteristics of it. Collectively, these characteristics form a voiceprint that enables a listener to recognise a voice as belonging to a particular individual, or someone sounding like that individual. They will also enable the singer to recognise themselves.

The system has the ability to group singers with similar key characteristics or voiceprints, and to combine their renditions. A compilation of these renditions will produce a rich, unified and pleasing sound. As an example, this process will enable a singer to assemble a “Choir of Me”, a virtual collective of singers with voices very similar to their own, or a virtual collective of singers who sound like a popular artist such as Elvis Presley, Beyonce, or Justin Bieber.

### Pitch Shifting of Sounds

While transposition is commonly associated with changing the key of a song by integral values of semitones, other levels of transposition, including non-integral multiples of semitones, may also be used. Transposition or pitch shifting is applied to any sound source, whether songful, musical or otherwise, by the application.

If multiple soundtracks of a performance are available, the application may apply a different transposition to each. For example, while the singer's voice and musical accompaniment may be transposed to a higher or lower key, the percussion instruments may be left unchanged.

Increasing the pitch of any note by one semitone corresponds to multiplying the pitch value or frequency by a factor which is the twelfth root of 2 (designated as

$$\sqrt[12]{2} )$$

which corresponds with a numerical value of 1.05946. Whereas, upward transposition by one semitone has the effect of multiplying every frequency in an audio signal by this factor. Similarly, decreasing the pitch of any note by one semitone corresponds to multiplying the pitch value or frequency by a factor which is the reciprocal of the twelfth root of 2 (designated as

$$1 / \sqrt[12]{2} )$$

which has a numerical value of (1/1.05946)=0.94387. Downward transposition by one semitone has the effect of multiplying every frequency in an audio signal by this factor.

For example, the musical note A4 has a frequency of 440 hertz. One semitone higher, the musical note A#4 has a frequency of (440*1.05946)=466.16 hertz. One semitone lower, the note Ab4 has a frequency of (440*0.94387)=415.30 hertz. Increasing the note A4 by 12 semitones results in a frequency of 440*(1.05946)¹²=880 hertz. As expected, this is the note A5, one octave higher than A4.

### Transposing Songs

Embodiments of the system may automatically determine the singer's comfortable vocal range so that a song may be optimally transposed to suit the singer. However, the system may undertake the reverse or inverse transposition, or another transposition, at a later stage of the audio processing to facilitate mixing or combining with other renditions, including those which may also have been transposed to suit other individual singers or groups. The application may combine renditions which have themselves be transposed to another key during various mixing processes.

With the high sampling frequencies employed in audio signal processing, the system will correctly transpose every audible sound frequency to another (either higher or lower) frequency by the same ratio. Thus, the integrity of songs is preserved and the duration of notes, and of the song itself, remain unaffected. However lower quality sound sources, for example for the singer's backing track, may be acceptable for providing the singer's backing track.

### Standard Transposition

The application will compare the song note range for the selected vocal line and the comfortable vocal range of the singer. If the singer's vocal range encompasses the song note range, the singer will be able to perform the song without transposition or other modification. The application will also allow for the singer to perform the song one or more octaves above or below the notes of the song.

If the singer's vocal range does not encompass the song range, or if the singer cannot successfully produce all of the notes or suitable substitutes, the application will determine the amount (in semitones) by which the song needs to be transposed to bring the note range of the singer's preferred vocal line within the singer's own comfortable vocal range. The match may either be exact or it may be within a predetermined tolerance threshold.

If the span of notes of the transposed vocal line is greater than the span within the singer's vocal range, it may be necessary for the singer to select a modified vocal line, with a span which is less than the singer's span, that they will sing from the options provided by the application. The modified vocal line may also be transposed so that all of its notes are within the singer's vocal range. The application will play the transposed song to the singer, the singer may then perform the song, confident that they can produce every note. In order to play the transposed song to the singer the application must suppress the playing of the song in its original key.

### Adaptive Transposition

If neither the vocal range of the singer nor the note range of a particular vocal line in the song are known, the application may still match the singer and the song. The application performs this function through an adaptive process by monitoring a singer's success in their attempts to sing a song and changing the key of the song if they are unable to successfully sing the higher or lower notes of the song. The application may also draw upon knowledge of a singer's performance in producing notes in previous performances of other songs, to identify which notes or pitches are achievable by the singer.

The application will monitor the sound signals for the song and separately monitor the singer's performance. The application will ascertain whether the singer is able to successfully and comfortably produce each of the notes contained within a vocal line of the song. It will be acceptable for the singer to perform the vocal line by singing the sung notes of the song, or by singing one or more octaves above or below the sung notes. If a singer does not sing the correct note, the application will normally retune it to the note played in the backing track.

If the application determines that there are certain high notes which the singer cannot comfortably produce, it will calculate the difference (in semitones) between the highest note of the song and the highest comfortable note of the singer. This sets the preferred amount by which the song should be transposed downwards to match the singer's vocal range, however an acceptable downward transposition may fall within a range between a tolerance threshold and the preferred amount by which the song should be transposed downwards.

If the application determines that there are certain low notes which the singer cannot comfortably produce, it will calculate the difference (in semitones) between the lowest note of the song and the lowest comfortable note of the singer. This sets the preferred amount by which the song should be transposed upwards to match the singer's vocal range, however an acceptable upward transposition may fall within a range between a tolerance threshold and the preferred amount by which the song should be transposed upward.

A tolerance threshold is set because transpositions of the artist's original song may produce one of the many number of unusual effects. For example, as well as the musical accompaniment; the artist, drums and other percussion instruments may sound a little unusual. In particular, the distinguishing vocal characteristics of the artist may not be readily recognised by the singer or by others familiar with the artist's songs.

### Transposition or Modification of the Rendition

The application may modify each rendition by a range of automated processing techniques. Audio renditions may be enhanced by the following processes performed by the application:
Noise reduction or cancellation.
Pitch correction or adjustment.
Formant preservation or adjustment.
Timing correction or adjustment.
Rates of attack and decay of sounds.
Frequency filtering.
Volume attenuation, amplification, compression, expansion or limiting of different sections or frequency bands of the rendition.
Volume attenuation or amplification to fit within or match an audio volume vs time envelope.
Removal or addition of reverberation.
Removal of extraneous sounds such as a cough.
Removal of extraneous sounds such as another singer.
Removal of distortion due to the choice of camera or microphone or technique for its use.
Modification or preservation of vocal elements such as Timbre and Formants.
Modification of vibrato, including addition, removal, accentuation or attenuation.
Musical key translation to a selected common starting key to be used for the later processing of all renditions.
Mixing across a combination of sound channels to obtain a fuller, stereo or surround sound as well as placing an individual rendition in the stereo or surround image.

Recordings of renditions of a selected song will be synchronised to the backing track, enabling the rendition, backing track and, if desired, other renditions to be combined in various ways and proportions.

Each modified recording is stored in the cloud in a form or forms that are compatible with all other similar recordings of an artistic work.

Existing open source and proprietary software is available for the processing of audio signals to achieve the modifications described above, including transposing by integral and non-integral numbers of semitones, pitch shifting, pitch correction, time shifting, time expansion or contraction, noise reduction, volume management. The application may utilise several of these tools when transposing a song or backing track to suit a singer's vocal range. They may also be used for polishing a singer's rendition to improve the quality of their recording. Each of these processing operations will endeavour to preserve those distinctive vocal features and characteristics which enable listeners to recognise a voice as belonging to a particular singer.

### Polishing Renditions

Renditions uploaded by performers may have minor imperfections, for example, minor errors in the timing of sections of the rendition, the timing of notes and sounds, minor differences between the note pitch and the intended pitch, undesirable fluctuations in volume, and the presence of noise etcetera. The embodiments described herein will correct or minimise any significant abnormalities and generate a polished version of the performer's rendition. The polished version of the performer's rendition will be stored for subsequent use in any mixes or compositions to which the singer contributes, including one or more mixes which feature the singer in a solo or prominent role.

### Reverse Transposition of the Rendition

Where the polished rendition is to be combined with other performances and the original track is in a different key from the backing track used by the singer, the singer's polished rendition will be transposed to the desired key prior to mixing.

### The Final Mixes

### Background

The process for producing compositions comprising one or more performers' renditions combined with a backing track as described in the present embodiments is scalable to include many contributions from performers and may, theoretically, include contributions from a substantially unlimited number of performers. At the very least, the present embodiment provides the ability to combine a very large number of audio renditions by singers, reciters and musicians.

The technical processes performed by the present embodiment ensure that each and every individual rendition makes a measurable difference to the final mix, even for very large numbers of performers. All audio renditions by performers of one particular type (e.g. singers) will make a similar level of contribution to the final mix. In addition, the contributions of various artists including singers, musicians and dance and other visual performers may all be combined to contribute to the final mix.

### Method

Each raw rendition from a performer (including replicated renditions from a group) is received by the application as a Level 0 rendition. It is processed to produce Polished Rendition (PR) which is then stored. Following this process, the confirmed PRs are classified as Level 1 renditions. They resemble the original Level 0 renditions very closely, but have been modified or enhanced according to the system and processes of the embodiment described above. The Level 1 renditions may then be submitted by the application to be combined with a backing track for a ‘Quick Mix’ composition.

### Basic Mix Compositions

The most basic mix or compilation comprises the polished audio renditions of all vocal performers who have submitted renditions prior to its production, and with all performers weighted equally. This basic whole mix will continue to evolve as new renditions are submitted. The mixing techniques employed during the production of the global mix compositions may be applicable. This basic compilation may be used as an unsophisticated backing track for the tailored or personalised compositions featuring one singer or a group of singers and may include the Quick Mix compositions discussed in the next section.

The basic mixes may also include basic group mixes, associated with a group of singers or vocal performers who have a close connection based on characteristics of the renditions, including the nature of the performance (vocal, instrumental, dance or other artistic modes), voice ranges (such as soprano, alto, tenor and bass), musical instrument types, language, affiliation of the performers with a special group such as a club or choir, a performer's geographic location, and other characteristics common to some portion of the performers. A basic group mix may be used as an unsophisticated backing track for the tailored or personalised compositions featuring one singer or a group of singers and which may include the Quick Mix compositions discussed in the next section.

### Quick Mix Compositions

As a Level 1 rendition is processed and polished it is added to a user-selected or automatically selected backing track and made available to the user for confirmation of their performance. Almost immediately the user may also receive a mix which includes the renditions of all other users who have submitted contributions at the time that the Quick Mix is produced, and which prominently comprises their own solo rendition. The main purpose of the Quick Mix is to confirm that the user has successfully submitted their rendition by providing a taste of the final composition. The user may choose to submit this final mix to the application's database of backing tracks for the user or other users to contribute to once again. While the user rapidly receives a composition that comprises all contributors to that point in time, the weighted contribution of each performer is not maintained.

In many cases, the user will have elected to sing the song in a key which is different from the original key in which the song is normally sung. The polished rendition of the singer will be transposed to the key in which the key is normally sung, and a second Quick Mix will be returned to the singer for their review. The singer may indicate a preference for either the version of their rendition in the key in which they performed the song, or the original key of the song, or some other key. A different preferred version may be selected for each final mix which feature the singer in a prominent role.

Audio and video file formats for the backing track, the performer's rendition, the processed and polished rendition, the mixed tracks, the final mix, and the output track returned to the user may be any format that is popular, easily used by the application and does not progressively degrade the audio or video quality. The sampling rate will be approximately 48 kHz and most of the processing will be performed in 32 bit floating point. The application also supports other sampling rates or precisions, depending on the user's hardware or other hardware which performs the processing.

Audio processing will involve normalising the maximum volume to something other than 0 dB, key changing, plan is not to use this style of autotune but to pitch correct to a MIDI track in one step, auto-adjustment of the start and duration of each sound (especially for sounds/syllables ending in consonants such as ‘t’ or ‘s’), and a review the attack and decay of each note. In addition, the application may add syllable envelopes, and enforced periods of (near) silence, within the overall volume envelope.

The system uses backing tracks (which are typically the original recording of a song installed from a CD or from a music download service) along with sheet music (typically retrieved from an online service in digital form such as PDF) and song lyrics (often retrieved with the sheet music or transcribed with timing manually) to generate a reference which is a set of instructions on how the singer in the song should sound. The melody line is extracted from the backing track using a vocal extraction technique which identifies the lead solo voice using spectral and other characteristics of the human voice. The melody line is extracted from the sheet music by first converting it to MusicXML format and then extracting just the appropriate notes.

The backing track is transposed to a range of different keys above and below the original in pitch equal to the range of keys that a user's vocal recording could be in. Software running on the user's device, typically in a browser then downloads or streams the backing track suited to the user's vocal range and downloads the lyrics. The backing track and/or lyrics may be retrieved from a third party.

When the user selects ‘start recording’ the backing track begins to play and the lyrics are displayed showing, via highlighting, where the progress of the song is up to. At this point the microphone (and optionally the camera) of the device is turned on to make the recording.

As the recording is made the software on the user's device captures the recording in small packets which are uploaded to a cloud server progressively. Should any packet not make it to the cloud server then the user will receive an error. The protocol between the device and the cloud server is able to correct errors and cause re-transmission when needed.

When the backing track has finished the microphone (and optionally the camera) are turned off. At this point the correction process described in FIG. 2a takes place. As this only takes a few seconds the user can wait but this is not a requirement. A quick mix is made using the backing track in the key in which the user sang (which may not be the same as the key of the backing track that the user listened to while singing). This mix is then made available to the user.

The recording is also corrected to the key of the original backing track. This version is then used for mixing with other recordings.

### Star Spangled Banner Scenario

A large number of patriotic singers has expressed interest in singing the melody of the American national anthem “The Star Spangled Banner” in unison as a group. With the aid of a backing track (derived from and synchronised with the original track), each singer will sing, record and upload their rendition at a time and place convenient to them. Their rendition may include both their audio and video performance, or other selected sounds and video.

The music to this song was originally written in G major, although the song is also commonly sung in A-flat or B-flat. One version of this song was arranged in 4 parts by Floyd Werle for performance by the USAF Band and Singing Sergeants. It has been scored in the key of Ab major, with the sopranos singing the melody.

Assuming an equal temperament musical scale with reference note A4=440 Hz. For the sopranos, the starting note is Eb4=311 Hz, the lowest note is Ab3=208 Hz, while the highest note is Eb5=622 Hz. The span of the melody of this song is 19 semitones.

There is a high likelihood that many singers will need the key changed, to fit their vocal range. As it is a tight fit, it is important that the comfortable vocal range of each singer be accurately determined prior to issuing them with their backing track. In the following table, it has been assumed that all singers have a generous vocal range spanning 20 or more semitones and that the women sing one octave higher than the men.

| | Vocal range | | SSB | SSB | Comment on an individual's |
|---|---|---|---|---|---|
| Voice | Low | High | Low | High | ability to sing this song |
| Soprano | C₄ | A₅ | A^{b}₃ | E^{b}₃ | Some may struggle with the |
| | | | | | low notes |
| Mezzo- | A₃ | F₃ | A^{b}₃ | E^{b}₃ | Comfortable for most |
| Sop | | | | | |
| Alto | F₃ | D₃ | A^{b}₃ | E^{b}₃ | Some may struggle at the |
| | | | | | top end |
| Tenor | B₂ | G₄ | A^{b}₂ | E^{b}₄ | A few may struggle with the |
| | | | | | low notes |
| Baritone | G₂ | E₄ | A^{b}₂ | E^{b}₄ | OK for most |
| Bass | E₂ | C₄ | A^{b}₂ | E^{b}₄ | Many will struggle to achieve |
| | | | | | the top notes |

Assuming an equal temperament musical scale with reference note A4=440 Hz. For the sopranos, the starting note is Eb4=311 Hz, the lowest note is Ab3=208 Hz, while the highest note is Eb5=622 Hz. The span of the melody of this song is 19 semitones.

While singers who have had training and experience might achieve the required span of notes, many other singers, including less experienced singers, will not. For some singers of the national anthem, it may be necessary to produce a modified version of the melody with a smaller span of notes. Even so, this example highlights the very real importance of determining a singer's range, and providing a backing track which matches it, so that they enjoy success in singing their national anthem.

### Bonus Track Scenario

As a final confirmation, and a fun celebration of their success, singers will be invited to sing an entire song that will be well known to them. Their device will play a few introductory bars of a backing track, whereupon the singer will join the accompaniment to sing Happy Birthday to themselves. The song has a span of 12 semitones (1 octave). The application will have selected a key for this song so that the notes are in the middle part of the singer's comfortable vocal range.

If the singer's name is Sophie, and their preferred language is English, the singer will be played an accompaniment and asked to sing:

Happy Birthday to you

Happy Birthday to you

Happy Birthday dear So-phie

Happy Birthday to you

The speed of the played song will be the same or similar for all singers, to facilitate the mixing of renditions by different singers. If the singer has achieved moderate success, the song will be immediately repeated, in the same key or a slightly higher key, and possibly at a slightly higher speed, with the singer invited to sing it again. This may be repeated, one or more times, to develop the singer's confidence, and to enable the system to select their best rendition.

Singers' renditions of Happy Birthday will be stored in the system library. They will contribute to collections of renditions of the songs to named individuals. The named collections will form the backing chorus for one or more singers wishing happy birthday to a person of the same name. Additionally, the full set may be used as a chorus for all parts of the song except for the name.

If the singer has a name with just one syllable (e.g. Sue), or a name with more than two syllables (e.g. Alexander), the singer should split or compress their name across the two notes of the song that are reserved for the name of the person celebrating their birthday (for example, ‘dear Sue-oo’ and ‘dear Alexan-der’, or just ‘Alex-an-der’ with the ‘dear’ omitted).

If the singer prefers, they may sing the song in another language, using lyrics that are most commonly employed in that language. The singer may also choose to sing the song in a higher or lower key than any key proffered by the application. The application will accompany the singer in their nominated key.

The system will store the singer's best rendition, noting the name of the recipient celebrated in the song. Selected parts of this rendition will be combined with other renditions of the Happy Birthday song in the singer's language.

In this way, every user of the App will have sung a rendition of the Happy Birthday song. In ways described elsewhere, the application will combine selected parts of this rendition with selections from all other users singing in that language. These combinations or mixes will be drawn upon whenever a user celebrates their own birthday, or whenever they submit another rendition of the Happy Birthday song that that they wish to direct to a relative, friend, colleague or other special person.

The backing track, in an appropriate key, will be synchronised to a full backing by the band that will accompany the millions of well-wishers singing happy birthday together! There will be no limit to the number of singers performing the song.

### Karaoke Scenario

100's of millions of people have an insatiable thirst for music and song. The world's 100 most popular artists have each amassed more than 1 billion views of their music videos. (Justin Bieber has over 15 Billion). Undoubtedly, the fans want to sing along, and not just listen. Using systems as described above, they can sing along Karaoke style with any song they hear, with enhanced confidence.

The advantage of the continuous recording and instant transposition described below is that the application can instantly transpose any song, even if it is not one in the database, and the singer can instantly sing along to it.

The application also provides an option for pop music lovers, including matching the aspiring singer's favourite songs to their own vocal range. The singer never has to fear not reaching the highest and lowest notes of any song whose span is less than their vocal span. Every song they play can be instantly transposed in real time to a key that matches their voice. As a safeguard to the singer, they will be warned if the span of notes in the song is greater than the span of their own vocal range.

The application can also immediately transpose the song to a key which matches the singer's vocal range (male or female) so that they can sing along ‘live’ to the instantly transposed song. Alternatively, the singer may choose to record a song which the application can transpose and play at a more convenient time.

For some songs, it may be possible to establish the range of notes within a particular vocal line in advance. In this case the application will compare it with the vocal range of the singer and automatically transpose the song to a more flattering key. Alternatively, the singer can control and adjust the level of transposition to their preferred key in real time. This too can be stored in the singer's database for future reference.

### New Compositions

The invention provides opportunities for composers, singers, musicians, poets and others to devise and promote their creative work, be it text, speech, singing, music, film, digital media or other forms of expression. Embodiments of the invention enable a composer to make their work available through the internet, and to provide opportunities for geographically and temporally distributed persons to perform the composer's work and submit it for inclusion in any of the forms of basic, quick and global mixes described earlier, and the production of final compositions. Through a virtual environment, the embodiment supports collaborations by geographically separated composers, artists and performers.

Using the system's composition tools, composers, arrangers, singers, musicians, poets and other artists developing creative works for text, speech, singing, music, film, digital media may develop new works and convert them into forms which will be the basis for aural or video backing tracks. Examples include: a writer, poet or lyricist submitting their composition as text and converting it to a sound file, either by a human reader, or by a speech synthesiser; a musical composer submitting their composition as one or more digital sound tracks and converting it to a backing track; digital media artists submitting audio, video or audio-visual material for incorporation with mixes.

Using speech synthesis techniques, selected text, in any language, may be automatically converted to a spoken form. The spoken text may be directly used as a backing track for recitations or petitions and, in modified form, for songs or other performance modes. This method allows rapid, efficient production, and subsequent editing, of any message to be spoken in unison by a large number of persons.

Composers, arrangers and artists may further use design augmentation techniques and tools to produce more complex forms or combinations. This may include adjusting the pace, timing and pitch of spoken or sung compositions; setting a poem to music; or combining the performances of geographically separated performers.

After a song composition has been submitted from the composer's location, a first artist in a first location may submit an instrumental arrangement of the song as a backing track. This track may be available in several keys including the key selected by the composer or first artist, a key selected by a second artist who intends to sing the song, or keys that best suit other artists who wish to sing with the backing of either an instrumental arrangement or a combined instrumental and vocal arrangement. All artists may perform their work at geographically spaced locations and at times of their choosing.

A creator can invite others to produce new versions, styles, arrangements of their work. These can then be published for users to produce renditions and/or select mixes.

### Additional Features

The application may communicate with third-party software to enhanced functionality, for instance the application may use Shazam or Soundhound to recognise the songs.

The application may also ascertain the song note range of a particular vocal line within the song by gaining it from a database if the song note range of the desired vocal line has been previously determined or published, or by listening to a song (comprising at least one voice or musical instrument performance, and possibly additional voices or instruments) as it is played, and establishing the note range of one or more selected vocal lines within it.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

While the invention has been described above in terms of specific embodiments, it is to be understood that the invention is not limited to these disclosed embodiments. Upon reading the teachings of this disclosure many modifications and other embodiments of the invention will come to the mind of those skilled in the art to which this invention pertains, and which are intended to be and are covered by both this disclosure and the appended claims.

It is indeed intended that the scope of the invention should be determined by proper interpretation and construction of the appended claims and their legal equivalents, as understood by those skilled in the art relying upon the disclosure in this specification and the attached drawings.

1. A computer readable non-transitory medium comprising computer-executable instructions for harmonising one or more geographically or temporally distributed renditions with at least one backing clip when executed by a computing device performing steps comprising:
selecting two or more parameters defining one or more aural characteristics of a first rendition characterised by multiple note blocks, the two or more parameters including a numerical representation of each note block and a time representation including the time and the duration of the note block, and determining one or more note attribute values for each numerical representation of each note block and each time representation of each note block,
filtering a collection of backing clips to select for a backing clip corresponding with a selected parameter,
selecting a reference generated from the backing clip or sheet music by determining one or more note attribute values providing a numerical representation of each note block and a time representation including the time and the duration of each note block of the backing clip, to act as a reference point for the modification of the first rendition,
applying a computational process to the first rendition or the backing clip to modify one or more note attribute values of an aural characteristic of the first rendition or the backing clip to reduce a difference between the first rendition or the backing clip and the reference in the one or more note attribute values for the numerical representation of each note block and the time representation of each note block, and
combining one or more renditions with the backing clip after modification,
wherein the resulting combination comprises a finished performance.

2. The computer readable non-transitory medium according to claim 1 wherein the step of applying is configured to locate the computational process by calling an application programming interface.

3. The computer readable non-transitory medium according to claim 1 wherein the computational process comprises the modification of a sequence of note attribute values of a first rendition or a backing clip to reduce the difference between the first rendition or the backing clip and the reference clip in the selected aural or visual characteristic.

4. The computer readable non-transitory medium according to claim 1 wherein the first rendition comprises one or more vocal performances of one or more user recordings, and the backing clip comprises the balance of the one or more user recordings excluding the one or more vocal performances.

5. The computer readable non-transitory medium according to claim 1 wherein the first rendition comprises one or more vocal performances of one or more user recordings excluding any background and incidental noise present in the one or more user recordings.

6. The computer readable non-transitory medium according to claim 1 wherein the first rendition or backing clip and the reference clip comprise data translations characterised by note attributes values.

7. The computer readable non-transitory medium according to claim 6 wherein the computational process comprises the modification of a sequence of note attributes values of the first rendition or backing clip to reduce the difference between the data translations of the first rendition or the backing clip and the reference clip in the selected aural or visual characteristic.

8. The computer readable non-transitory medium according to claim 7 wherein the one or more user recordings comprise a video recording of the vocal performance.

9. A system for harmonising one or more geographically or temporally distributed renditions with at least one backing clip comprising:
a computing device for executing a computer-executable instructions on one computer readable non-transitory medium, capturing a first rendition and communicating the first rendition to a software application, wherein the computing device further comprises;
a processor,
a memory,
a camera or microphone,
a signal transmitter,
a signal receiver, and
a user interface,
the computer readable instructions further comprising;
a calibration module for selecting two or more parameters defining one or more aural characteristics of a first rendition characterised by multiple note blocks, the two or more parameters including a numerical representation of each note block and a time representation including the time and the duration of the note block, and determining note attribute values for each numerical representation of each note block and each time representation of each note block
a backing clip selector in communication with a backing clip database configured to filter a collection of backing clips to select for a backing clip corresponding with the selected parameter,
a reference selector for selecting a reference generated from the backing clip or sheet music by determining one or more note attribute values providing a numerical representation of each note block and a time representation including the time and the duration of each note block of the backing clip, to act as a reference point for the modification of the first rendition,
a modification module for applying a computational process to the first rendition or the backing clip to modify one or more note attribute values of an aural characteristic of the first rendition or the backing clip to reduce a difference between the first rendition and the reference in the one or more note attribute values for the numerical representation of each note block and the time representation of each note block, and
a mixing module for combining one or more renditions with the backing clip after modification,
wherein the resulting combination comprises a finished performance.

10. A system according to claim 9 comprising a software application according to claim 1.

11. A system according to claim 10 comprising an application programming interface configured to allow the execution of the computational process of claim 2 to modify an aural or visual characteristic of the first rendition or the backing clip to reduce the difference between the first rendition or the backing clip and the reference clip in the selected aural or visual characteristic.

12. A system according to claim 11 comprising a server having the application programming interface, wherein the server is configured to execute the computational process of claim 2.

13. A method for harmonising one or more geographically or temporally distributed renditions with at least one backing clip comprising the steps of:
selecting a reference generated from the backing clip or sheet music by determining one or more note attribute values providing a numerical representation of each note block and a time representation including the time and the duration of each note block of the backing clip, to act as a reference point for the modification of the first rendition;
generating a first rendition by a user;
calibrating the first rendition to select two or more parameters defining one or more aural characteristics of a first rendition characterised by multiple note blocks, the two or more parameters including a numerical representation of each note block and a time representation including the time and the duration of the note block, and determining note attribute values for each numerical representation of each note block and each time representation of each note block;
selecting a backing clip from a backing clip database for combining with a first rendition;
applying a computational process to the first rendition or backing clip to modify one or more note attribute values of an aural characteristic of the first rendition or the backing clip to reduce a difference between the first rendition and the reference in one or more note attribute values for the numerical representation of each note block and the time representation of each note block; and
combining the first rendition, or the first rendition and more renditions, and the backing clip after modification to produce a first performance;
wherein the resulting combination comprises a finished performance.

14. A method according to claim 13 wherein the computational process comprises the modification of a sequence of note attribute values of a first rendition or a backing clip to reduce the difference between the first rendition or the backing clip and the reference clip in the selected aural or visual characteristic.

15. A method according to claim 13 wherein the computational process comprises the step of splitting one or more vocal performances from one or more user recordings, wherein the balance of the one or more user recordings excluding the one or more vocal performances remains.

16. A method according to claim 13 wherein the computational process comprises the step of removing any background or incidental noise from the one or more vocal performances by recognising the one or more vocal performances within the one or more user recordings and removing all sound from the one or more user recordings that is not recognised as the vocal performance.

17. A method according to claim 13 wherein the computational process comprises the step of analysing the first rendition or backing clip and the reference clip, translating them into data characterised by note attribute values, and reducing the difference between the note attribute values of the first rendition or backing clip and the reference clip.

18. A method according to claim 17 wherein the computational process comprises the step of modifying a sequence of note attribute values of the first rendition or backing clip to reduce the difference between the data translations of the first rendition or the backing clip and the reference clip in the selected aural or visual characteristic.

19. A method according to claim 18 wherein the computational process comprises the step of modifying a video recording of the vocal performance.
